(19) United States
(12) Patent Application Publication
(10) Pub. No.: US 2025/0015553 A1
(43) Pub. Date: Jan. 9, 2025

(54) DEVICE FOR GENERATING LASER WITH ULTRA-NARROW-LINEWIDTH

(71) Applicant: Zhejiang University, Hangzhou (CN)

(72) Inventors: Xiaofeng JIN, Hangzhou (CN); Ling YANG, Hangzhou (CN); Ziyue WANG, Hangzhou (CN); Hanfeng XU, Hangzhou (CN); Bing WEI, Hangzhou (CN); Xiangdong JIN, Hangzhou (CN); Yinfang XIE, Hangzhou (CN)

(21) Appl. No.: 18/764,294

(22) Filed: Jul. 4, 2024

(30) Foreign Application Priority Data
Jul. 4, 2023 (CN) 2023108109783

(51) Int. Cl. H01S 3/10; H01S 3/067; H01S 3/08; H01S 3/0941; H01S 3/16; H04B 10/50

(52) U.S. Cl. CPC H01S 3/10092; H01S 3/06716; H01S 3/08013; H01S 3/0941; H01S 3/10053; H01S 3/10061; H01S 3/1608; H01S 2301/02; H04B 10/503

(57) ABSTRACT

A device for generating laser with ultra-narrow-linewidth includes an optical self-injection locking loop and an ultra-stable cavity phase-locked loop. The optical self-injection locking loop improves the quality factor of the laser resonator to narrow the linewidth. The ultra-stable cavity phase-locked loop locks the phase of the optical signal in the optical self-injection, synchronizing the laser frequency with the optical resonator. Through feedback control of the laser's driving current, it further reduces the laser's frequency noise and enhances the linewidth narrowing rate. Additionally, the ultra-stable cavity phase-locked loop provides stable control of the laser frequency, preventing mode hopping caused by laser frequency drift, thereby improving system stability. Therefore, this device can provide a stable narrow-linewidth laser source for applications in fiber optic communication, lidar, industrial device processing, and medical fields.

### CROSS-REFERENCE TO RELATED APPLICATIONS

This application claims a priority to Chinese Patent Application No. 2023108109783, filed Jul. 4, 2023, entitled “DEVICE FOR GENERATING LASER WITH ULTRA-NARROW-LINEWIDTH,” which is hereby incorporated by reference in its entirety.

### TECHNICAL FIELD

The present invention belongs to the field of optoelectronics, specifically relating to a device for generating laser with ultra-narrow-linewidth.

### BACKGROUND OF THE INVENTION

Laser, which stands for Light Amplification by Stimulated Emission of Radiation, refers to the emission of a photon beam with optical properties highly consistent with the stimulating photon when high-energy particles are excited by external photons and transition to a lower energy level. Therefore, compared to ordinary light sources, lasers have advantages such as monochromaticity and directionality, making them widely used in fields like fiber optic communications, lidar, industrial device processing, and medical applications. Ideally, a laser would only involve stimulated emission, with energy loss of high-energy atoms replenished during stimulation, and the generated light wave coherently superimposed with the original light wave, maintaining a constant amplitude in the resonant cavity, resulting in an infinitely narrow-linewidth. However, due to spontaneous emission, the gain of stimulated emission in a laser is slightly less than the total loss in the cavity, leading to the overlap of incoherent light waves with coherent light generated by stimulated emission, thus broadening the laser linewidth. Additionally, in practical applications, process and environmental factors cause inevitable frequency drift and phase jitter in lasers, reflected as broadening in the power spectrum. For instance, in coherent optical communication, laser linewidth broadening deteriorates the signal-to-noise ratio at the receiving end, affecting communication quality. Therefore, narrow-linewidth lasers are indispensable in laser applications. Currently, the linewidth of commercially mature distributed feedback semiconductor lasers is around megahertz, which is sufficient for general applications but insufficient for precise optical measurements and high-quality microwave photonic signal generation. Moreover, commercially available narrow-linewidth lasers are very expensive, significantly increasing system costs. Hence, researchers aim to narrow the laser linewidth through other external structures.

Optical self-injection locking technology is a method to narrow laser linewidth. It achieves linewidth narrowing by coupling a portion of the laser output back into the laser through a circulator. Thus, the optical self-injection locking system has a very simple structure and can achieve a high linewidth narrowing rate. However, self-injection effectively increases the resonator's loop length to obtain a higher resonator quality factor (Q value). Consequently, a longer loop length introduces greater phase jitter, reduces the free spectral range, and more longitudinal modes meet the oscillation conditions, resulting in a lower side-mode suppression ratio, significantly limiting the laser's frequency stability. Therefore, researchers propose adding a narrowband optical filter to the feedback loop to filter out unwanted modes. Common narrowband filters include Fabry-Pérot resonators, grating resonators, and whispering gallery mode resonators. However, the smaller free spectral range imposes higher requirements on the quality factor of the narrowband filter. Additionally, as feedback injected light increases, the linewidth narrowing rate of optical self-injection locking tends to saturate, generally ranging from a few hundred to about a thousand times.

### SUMMARY OF THE INVENTION

In view of the above, the present invention provides a device for generating laser with ultra-narrow-linewidth. This device offers a higher linewidth narrowing rate and lower frequency noise compared to optical self-injection locking, while avoiding the use of very high Q-value optical resonators, thereby reducing system cost.

The device for generating laser with ultra-narrow-linewidth includes an optical self-injection locking loop and an ultra-stable cavity phase-locked loop; the optical self-injection locking loop is configured to improve the resonant quality factor of the laser resonator and narrow the laser linewidth; the ultra-stable cavity phase-locked loop is configured to stabilize the phase of the optical signal in the optical self-injection locking loop and further reduce the laser frequency noise through feedback control of the laser current; the combination of the optical self-injection locking loop and the ultra-stable cavity phase-locked loop achieves high stability oscillation frequency for laser with ultra-narrow-linewidth output.

The optical self-injection locking loop includes a laser, an optical circulator, two optical fiber couplers, a phase modulator, an ultra-stable optical resonator, a polarization controller, an erbium-doped fiber amplifier (EDFA), an optical bandpass filter, and a piezoelectric ceramic controller; the ultra-stable cavity phase-locked loop includes a laser, an optical circulator, two optical fiber couplers, a phase modulator, an ultra-stable optical resonator, an avalanche photodiode, an electrical bandpass filter, an analog signal source, an electrical power splitter, a mixer, a loop filter, an amplifier, a servo circuit, an adder circuit, and a constant current source; the optical self-injection locking loop and the ultra-stable cavity phase-locked loop share common components, including a laser, an optical circulator, two optical fiber couplers, a phase modulator, and an optical resonator.

Furthermore, the optical self-injection locking loop includes: a laser for generating an optical signal L1 to the second port of the optical circulator; the optical circulator for unidirectional transmission of optical signal L1 from the second port to the third port of the optical circulator, with the output optical signal from the third port referred to as L2, which is transmitted to the first optical fiber coupler; the first optical fiber coupler for splitting optical signal L2 into two optical signals L31 and L32, with L31 transmitted to the phase modulator and L32 being the narrow-linewidth laser signal output from the device; the phase modulator for modulating electrical signal E22 onto optical signal L31 to generate optical signal L4, which is transmitted to the optical resonator; the optical resonator for causing different phase changes in the two sidebands of optical signal L4 after passing through the resonator, with the resulting optical signal referred to as L5, which is transmitted to the second optical fiber coupler; the second optical fiber coupler for splitting optical signal L5 into two optical signals L61 and L62, with L61 transmitted to the EDFA and L62 transmitted to the avalanche photodiode; the EDFA for amplifying optical signal L61 to generate optical signal L7, which is transmitted to the optical bandpass filter; the optical bandpass filter for reducing the spontaneous emission noise introduced by the EDFA in optical signal L7 and outputting optical signal L8 to the polarization controller; the polarization controller for adjusting the polarization state of the optical self-injection locking loop, outputting optical signal L9 to the piezoelectric ceramic controller; the piezoelectric ceramic controller, controlled by electrical signal E7, for finely adjusting the length of the optical self-injection locking loop and outputting optical signal L10 to the first port of the optical circulator; optical signal L10 enters the first port of the optical circulator and is transmitted unidirectionally to the second port, thereby being reinjected into the laser to form a complete optical self-injection locking loop.

The ultra-stable cavity phase-locked loop includes: a laser for generating an optical signal L1 to the second port of the optical circulator; the optical circulator for unidirectional transmission of optical signal L1 from the second port to the third port of the optical circulator, with the output optical signal from the third port referred to as L2, which is transmitted to the first optical fiber coupler; the first optical fiber coupler for splitting optical signal L2 into two optical signals L31 and L32, with L31 transmitted to the phase modulator and L32 being the narrow-linewidth laser signal output from the device; the phase modulator for modulating electrical signal E22 onto optical signal L31 to generate optical signal L4, which is transmitted to the optical resonator; the optical resonator for causing different phase changes in the two sidebands of optical signal L4 after passing through the resonator, with the resulting optical signal referred to as L5, which is transmitted to the second optical fiber coupler; the second optical fiber coupler for splitting optical signal L5 into two optical signals L61 and L62, with L61 transmitted to the EDFA and L62 transmitted to the avalanche photodiode; the avalanche photodiode for converting optical signal L62 into electrical signal E1, which is transmitted to the electrical bandpass filter; the electrical bandpass filter for filtering electrical signal E1 and outputting electrical signal E2 to the RF port of the mixer; the analog signal source for generating reference electrical signal E3, which is transmitted to the electrical power splitter; the electrical power splitter for dividing electrical signal E3 into equal power electrical signals E41 and E42 with a phase difference of 90°, with E42 transmitted to the phase modulator and E41 transmitted to the local oscillator port of the mixer; the mixer for comparing the phase difference between electrical signals E41 and E2 to obtain electrical signal E5, which is transmitted to the loop filter; the loop filter for integrating and processing electrical signal E5 to generate electrical signals E61 and E62, with E61 transmitted to the amplifier and E62 transmitted to the servo circuit; the amplifier for amplifying control signal E61 to generate electrical signal E7 to control the piezoelectric ceramic controller; the servo circuit for converting electrical signal E62 into current signal E8, which is transmitted to the adder circuit; the adder circuit for adding current signal E8 with current signal E9 output by the constant current source to obtain feedback control current E10 for the laser; electrical signal E7 for controlling the piezoelectric ceramic controller to control the phase of the optical signal in the optical self-injection locking loop, and electrical signal E10 for feedback control of the laser current to reduce laser phase noise, together achieving closed-loop control of the ultra-stable cavity phase-locked loop.

The device of the present invention includes an optical self-injection locking loop and an ultra-stable cavity phase-locked loop, where the optical self-injection locking loop enhances the quality factor of the laser resonator to narrow the linewidth, and the ultra-stable cavity phase-locked loop adjusts the loop length of the optical self-injection locking loop and the driving current of the laser, achieving synchronization between the laser frequency and the optical resonator, thereby further reducing the laser frequency noise and increasing the linewidth narrowing rate; simultaneously, the ultra-stable cavity phase-locked loop provides stable control of the laser frequency, avoiding mode-hopping phenomena caused by laser frequency drift and improving system stability. Therefore, the device of the present invention can provide a stable narrow-linewidth laser source for applications in fiber optic communications, lidar, industrial device processing, and medical fields.

### BRIEF DESCRIPTION OF DRAWINGS

FIG. 1 is a schematic diagram of the specific structure of the device of the present invention.

FIG. 2 is an s-domain model block diagram of the device of the present invention.

In the figures: 1—laser; 2—optical circulator; 3—first optical fiber coupler; 4—phase modulator; 5—optical resonator; 6—second optical fiber coupler; 7—EDFA; 8—optical bandpass filter; 9—polarization controller; 10—piezoelectric ceramic controller; 11—avalanche photodiode; 12—electrical bandpass filter; 13—mixer; 14—analog signal source; 15—electrical power splitter; 16—loop filter; 17—electrical amplifier; 18—servo circuit; 19—adder circuit; 20—constant current source.

### DETAILED DESCRIPTION OF THE INVENTION

To describe the present invention in more detail, the technical solution of the invention is explained below with reference to the accompanying drawings and specific embodiments.

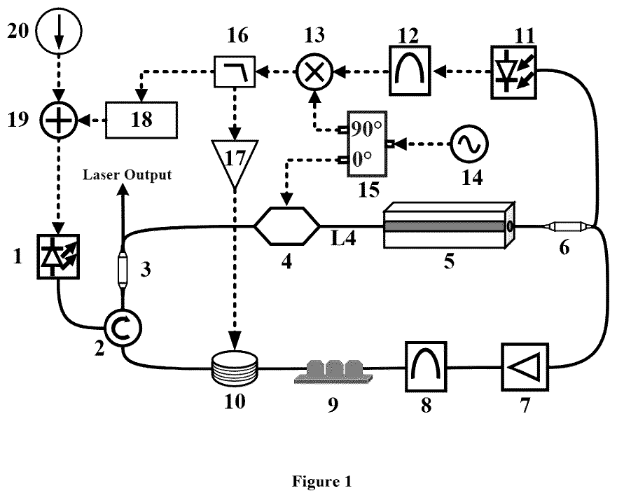

As shown in FIG. 1, a device for generating laser with ultra-narrow-linewidth includes an optical self-injection locking loop and an ultra-stable cavity phase-locked loop. The optical self-injection locking loop is configured to improve the resonant quality factor (Q value) of the laser resonator and narrow the laser linewidth. The ultra-stable cavity phase-locked loop is configured to stabilize the phase of the optical signal in the optical self-injection locking loop and further reduce the laser frequency noise through feedback control of the laser current. The combination of the optical self-injection locking loop and the ultra-stable cavity phase-locked loop achieves high stability oscillation frequency for laser with ultra-narrow-linewidth output.

The optical self-injection locking loop includes a laser 1, an optical circulator 2, a first optical fiber coupler 3, a phase modulator 4, an optical resonator 5, a second optical fiber coupler 6, an EDFA 7, an optical bandpass filter 8, a polarization controller 9, and a piezoelectric ceramic controller 10. These components are connected via optical fibers. The first optical fiber coupler 3 and the second optical fiber coupler 6 are both 1×2 optical fiber couplers. Specifically, the laser 1 is connected to the optical circulator 2; the optical circulator 2 is connected to the first optical fiber coupler 3; the first optical fiber coupler 3 is connected to the phase modulator 4; the phase modulator 4 is connected to the optical resonator 5; the optical resonator 5 is connected to the second optical fiber coupler 6; the second optical fiber coupler 6 is connected to the EDFA 7; the EDFA 7 is connected to the optical bandpass filter 8; the optical bandpass filter 8 is connected to the polarization controller 9; the polarization controller 9 is connected to the piezoelectric ceramic controller 10; and the piezoelectric ceramic controller 10 is connected to the optical circulator 2.

An optical circulator is a multi-port optical device with non-reciprocal characteristics. When an optical signal is input from any port, it can be output from the next port in sequence with very little loss, while the loss to all other ports is significant, making them isolated ports. In this embodiment, the optical circulator 2 can be a three-port optical circulator. The optical circulator 2 includes a first port, a second port, and a third port arranged sequentially. The second port is the next port to the first port, the third port is the next port to the second port, and the first port is the next port to the third port. Thus, as shown in FIG. 1, the laser 1 is connected to the second port of the optical circulator 2, the first optical fiber coupler 3 is connected to the third port of the optical circulator 2, and the piezoelectric ceramic controller 10 is connected to the first port of the optical circulator 2. Based on this, the optical signal is input to the optical circulator 2 through the second port and output from the third port to the first optical fiber coupler 3. Meanwhile, after passing through the piezoelectric ceramic controller 10, the optical signal enters the optical circulator 2 from the first port and is ultimately output from the second port back to the laser 1. It is understood that in other embodiments, the optical circulator may also be a four-port or more-port optical circulator, as long as the input and output ports are properly matched so that the optical signal output by the laser 1 enters the loop through the optical circulator 2 and finally returns to the laser 1 through the optical circulator 2.

An optical fiber coupler, also known as a splitter, connector, adapter, or optical fiber flange, is configured to realize optical signal splitting/combining or to extend the optical fiber link. In this embodiment, the first optical fiber coupler 3 and the second optical fiber coupler 6 are both 1×2 optical fiber couplers. The working principle of a 1×2 optical fiber coupler is based on coupling and interference. The optical signal from the input end propagates through the optical fiber to the coupler, where it is split into two parts and transmitted to two output ends. Typically, the splitting ratio is 50:50, meaning the optical signal is evenly distributed to the two output ends. As shown in FIG. 1, the optical signal exits the optical circulator 2 and enters the first optical fiber coupler 3. The optical signal is split into two parts in the first optical fiber coupler 3, with one part output to the phase modulator 4. After passing through the phase modulator 4 and the optical resonator 5, the optical signal enters the second optical fiber coupler 6. The optical signal entering the second optical fiber coupler 6 is split into two parts, with one part output to the EDFA 7 and the other part entering the avalanche photodiode 11.

In this example, as shown in FIG. 1, the laser 1 generates an optical signal L1 to the second port of the optical circulator 2. The optical circulator 2 enables unidirectional transmission of the optical signal L1 from the second port of the optical circulator 2 to the third port of the optical circulator 2. The output optical signal from the third port of the optical circulator 2 is designated as L2, which is transmitted to the first optical fiber coupler 3. The first optical fiber coupler 3 splits the optical signal L2 into two optical signals L31 and L32. The optical signal L31 is transmitted to the phase modulator 4, and the optical signal L32 is the narrow-linewidth laser produced by the device. The phase modulator 4 modulates an electrical signal E22 onto the optical signal L31, generating an optical signal L4. The optical signal L4 is transmitted to the optical resonator 5. After passing through the optical resonator 5, the two sidebands of the optical signal LA undergo different phase changes. The optical signal L4 after passing through the optical resonator 5 is designated as an optical signal L5, which is transmitted to the second optical fiber coupler 6. The second optical fiber coupler 6 splits the optical signal L5 into two optical signals L61 and L62. The optical signal L61 is transmitted to the EDFA 7, and the optical signal L62 is transmitted to the avalanche photodiode 11. The EDFA 7 amplifies the optical signal L61 to produce an optical signal L7, which is then transmitted to the optical bandpass filter 8. The optical bandpass filter 8 reduces the spontaneous emission noise introduced by the EDFA in the optical signal L7 and outputs an optical signal L8, which is transmitted to the polarization controller 9. The polarization controller 9 adjusts the polarization state of the optical self-injection locking loop, and the optical signal L8, after passing through the polarization controller 9, is output as an optical signal L9 to the piezoelectric ceramic controller 10. The piezoelectric ceramic controller 10, controlled by an electrical signal E7, finely adjusts the length of the optical self-injection locking loop and outputs ab optical signal L10 to the first port of the optical circulator 2. The optical signal L10 enters the first port of the optical circulator 2 and is unidirectionally transmitted to the second port of the optical circulator 2, thus reinjecting into the laser 1 to form a complete optical self-injection locking loop.

The optical signal output by the laser I returns to the laser 1 after passing through the optical self-injection locking loop, effectively increasing the ring length of the resonant cavity of the laser 1 and thereby improving the quality factor (Q value) of the laser 1, thus reducing the linewidth of the laser 1. However, due to the increased ring length and the effect of gain competition, adjacent modes may also meet the oscillation conditions, leading to possible mode hopping. Therefore, adding an optical resonator to the loop to filter out unwanted modes can improve system stability.

The ultra-stable cavity phase-locked loop includes the laser 1, the optical circulator 2, the first optical fiber coupler 3, the phase modulator 4, the optical resonator 5, the second optical fiber coupler 6, an avalanche photodiode 11, an electrical bandpass filter 12, a mixer 13, an analog signal source 14, an electrical power splitter 15, a loop filter 16, an amplifier 17, a servo circuit 18, an adder circuit 19, and a constant current source 20. Be noted that, as shown in FIG. 1, the ultra-stable cavity phase-locked loop shares the laser 1, the optical circulator 2, the first optical fiber coupler 3, the phase modulator 4, the optical resonator 5, and the second optical fiber coupler 6 with the optical self-injection locking loop. More specifically, in the ultra-stable cavity phase-locked loop, the laser 1 is connected to the optical circulator 2; the optical circulator 2 is connected to the first optical fiber coupler 3; the first optical fiber coupler 3 is connected to the phase modulator 4; the phase modulator 4 is connected to the optical resonator 5; the optical resonator 5 is connected to the second optical fiber coupler 6; the second optical fiber coupler 6 is connected to the avalanche photodiode 11; the avalanche photodiode 11 is connected to the electrical bandpass filter 12; the electrical bandpass filter 12 is connected to the mixer 13; the mixer 13 is connected to the loop filter 16; and the piezoelectric ceramic controller 10 is connected to the optical circulator 2. The loop filter 16 is connected to the amplifier 17 and the servo circuit 18. The amplifier 17 is connected to the piezoelectric ceramic controller 10. The servo circuit 18 is connected to the adder circuit 19. The constant current source 20 is connected to the adder circuit 19. The adder circuit 19 is connected to the laser 1. The analog signal source 14 is connected to the electrical power splitter 15. The electrical power splitter 15 has two ports with a phase difference of 90°, one of which is connected to the mixer 13 and the other to the phase modulator 4.

In the ultra-stable cavity phase-locked loop, the laser 1, the optical circulator 2, the first optical fiber coupler 3, the phase modulator 4, the optical resonator 5, the second optical fiber coupler 6, and the avalanche photodiode 11 are all connected via optical fibers. The electrical bandpass filter 12, the analog signal source 14, the electrical power splitter 15, and the mixer 13 are connected via coaxial cables. The loop filter 16, the amplifier 17, the servo circuit 18, the adder circuit 19, and the constant current source 20 are connected via copper wires.

In the ultra-stable cavity phase-locked loop, the laser generates an optical signal L1 to the second port of the optical circulator 2. The optical circulator 2 enables unidirectional transmission of the optical signal L1 from the second port of the optical circulator 2 to the third port of the optical circulator 2. The output optical signal from the third port of the optical circulator 2 is designated as an optical signal L2, which is then transmitted to the first optical fiber coupler 3. The first optical fiber coupler 3 splits the optical signal L2 into two optical signals L31 and L32. The optical signal L31 is transmitted to the phase modulator 4, and the optical signal L32 is the narrow-linewidth laser produced by the device. The phase modulator 4 modulates the electrical signal E22 onto the optical signal L31, generating an optical signal L4, which is transmitted to the optical resonator 5. In the optical resonator 5, the two sidebands of the optical signal L4 undergo different phase changes after passing through the optical resonator. The optical signal L4 after passing through the optical resonator 5 is designated as an optical signal L5, which is then transmitted to the second optical fiber coupler 6. The second optical fiber coupler 6 splits the optical signal L5 into two optical signals L61 and L62. The optical signal L61 is transmitted to the EDFA 7, and the optical signal L62 is transmitted to the avalanche photodiode 11. The avalanche photodiode 11 converts the optical signal L62 into an electrical signal E1, which is transmitted to the electrical bandpass filter 12. The electrical bandpass filter 12 filters the electrical signal E1 and outputs an electrical signal E2 to the radio frequency (RF) port of the mixer 13. The analog signal source 14 generates a reference electrical signal E3 and transmits the electrical signal E3 to the electrical power splitter 15. The electrical power splitter 15 divides the electrical signal E3 into equal power electrical signals E41 and E42 with a phase difference of 90°. The electrical signal E42 is transmitted to the phase modulator 4, and the electrical signal E41 is transmitted to the local oscillator port of the mixer 13. The mixer 13 compares the phase difference between the electrical signals E41 and E2 to obtain an electrical signal E5 and transmits the electrical signal E5 to the loop filter 16. The loop filter 16 integrates and processes the electrical signal E5 to generate electrical signals E61 and E62. The electrical signal E61 is transmitted to the amplifier 17, and the electrical signal E62 is transmitted to the servo circuit 18. The amplifier 17 amplifies the control signal E61 to generate the electrical signal E7 to control the piezoelectric ceramic controller 10. The servo circuit 18 converts the electrical signal E62 into an electrical signal E8 and transmits the electrical signal E8 to the adder circuit 19. The adder circuit 19 adds the electrical signal E8 and a current signal E9 output by the constant current source 20 to obtain a feedback control current E10 for the laser 1. It should be noted that the electrical signal E7 is configured to control the piezoelectric ceramic controller 10 to control the phase of the optical signal in the optical self-injection locking loop. The electrical signal E10 is configured to feedback control the current of the laser 1 to reduce the phase noise of the laser 1, achieving closed-loop control of the ultra-stable cavity phase-locked loop.

The specific operation is as follows: First, adjust the frequency of the laser 1 to be near the resonant frequency of the ultra-stable optical cavity. The ultra-stable cavity phase-locked loop converts the information on the laser frequency deviation from the optical resonator 5 into a voltage signal. Simultaneously, when the laser 1 is locked by optical self-injection, the laser frequency will meet the oscillation conditions determined by the increased loop length. Therefore, by finely adjusting the loop length, the laser frequency can be synchronized with the optical resonator 5, reducing laser frequency noise caused by loop jitter. Meanwhile, the high-frequency component of the control signal is configured to control the driving current of the laser, reducing frequency noise caused by current noise. Consequently, the laser frequency noise can be further suppressed, meaning the laser linewidth is further narrowed.

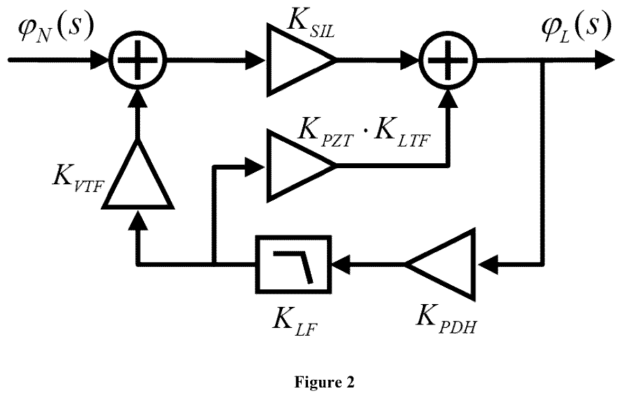

In this embodiment, FIG. 2 shows the s-domain model of the device for generating laser with ultra-narrow-linewidth of the present invention. From FIG. 2, it can be observed that when the ultra-stable cavity phase-locked loop control is not applied, the input noise passes through the optical self-injection locking structure and becomes the system's output noise, resulting in a noise suppression gain of KSIL, where KSIL is much less than 1, indicating the suppression effect of optical self-injection locking on frequency noise. After incorporating the ultra-stable cavity phase-locked loop for feedback control, the frequency noise suppression gain of the closed-loop system can be derived as:

$$\frac{{φ}_{L} ( s )}{{φ}_{N} ( s )} = \frac{{K}_{SIL}}{1 + {K}_{PDH} {F}_{LF} ( {K}_{SIL} {F}_{VTF} + {K}_{LTF} {F}_{PZT} )}$$

Where, φ_{L} represents the output frequency noise of the laser, φ_{N} represents the input frequency noise of the laser, K_{PDH} represents the frequency discrimination gain of the ultra-stable cavity phase-locked loop, F_{LF} represents the transfer function of the loop filter, F_{VTF} represents the frequency response of the laser current modulation, F_{PZT} represents the frequency response of the piezoelectric ceramic controller, and K_{LTF} represents the laser frequency response to the loop length in optical self-injection locking. Therefore, compared to a single optical self-injection locking system, the proposed structure can improve the optical phase noise suppression ratio by a factor of 1+K_{PDH}F_{LF}(K_{SIL}F_{VTF}+K_{LTF}F_{PZT}).

The description of the embodiments above is provided to enable those skilled in the art to better understand and apply the present invention. Those skilled in the art can readily make various modifications to the above embodiments and apply the general principles described herein to other embodiments without involving inventive labor. Therefore, the present invention is not limited to the above embodiments, and any improvements and modifications made by those skilled in the art based on the disclosure of the present invention should fall within the scope of protection of the present invention.

1. A device for generating laser with ultra-narrow-linewidth, comprising an optical self-injection locking loop and an ultra-stable cavity phase-locked loop; the optical self-injection locking loop is configured to improve the resonant quality factor of the laser resonator and narrow the laser linewidth; the ultra-stable cavity phase-locked loop is configured to stabilize the phase of the optical signal in the optical self-injection locking loop and further reduce the laser frequency noise through feedback control of the laser current; the combination of the optical self-injection locking loop and the ultra-stable cavity phase-locked loop achieves high stability oscillation frequency for laser with ultra-narrow-linewidth output.

2. The device according to claim 1, wherein the optical self-injection locking loop comprises:
a laser, for generating an optical signal L1 to a second port of an optical circulator;
the optical circulator, for unidirectional transmission of the optical signal L1 from the second port to a third port of the optical circulator; wherein an optical signal L2 output from the third port is transmitted to the first optical fiber coupler;
the first optical fiber coupler, for splitting the optical signal L2 into two optical signals L31 and L32, with the optical signal L31 transmitted to a phase modulator and the optical signal L32 being a narrow-linewidth laser output from the device;
the phase modulator, for modulating an electrical signal E22 onto the optical signal L31 to generate an optical signal LA, which is then transmitted to an optical resonator;
the optical resonator, for causing different phase changes in two sidebands of the optical signal LA after passing through the optical resonator, and generating an optical signal L5 which is transmitted to a second optical fiber coupler;
the second optical fiber coupler, for splitting the optical signal L5 into two optical signals L61 and L62, with the optical signal L61 transmitted to an EDFA and the optical signal L62 transmitted to an avalanche photodiode;
the EDFA, for amplifying the optical signal L61 to generate an optical signal L7, which is transmitted to an optical bandpass filter;
the optical bandpass filter, for reducing spontaneous emission noise introduced by the EDFA in the optical signal L7 and outputting an optical signal L8 to a polarization controller;
the polarization controller, for adjusting a polarization state of the optical self-injection locking loop, outputting an optical signal L9 to a piezoelectric ceramic controller; and
the piezoelectric ceramic controller, controlled by an electrical signal E7, for finely adjusting a length of the optical self-injection locking loop and outputting an optical signal L10 to a first port of the optical circulator; wherein the optical signal L10 enters the first port of the optical circulator and is transmitted unidirectionally to the second port, thereby being reinjected into the laser to form a complete optical self-injection locking loop.

3. The device according to claim 1, wherein the ultra-stable cavity phase-locked loop includes:
the laser, for generating the optical signal L1 to the second port of the optical circulator;
the optical circulator, for unidirectional transmission of the optical signal L1 from the second port to the third port of the optical circulator, with the output optical signal from the third port referred to as L2, which is transmitted to the first optical fiber coupler;
the first optical fiber coupler, for splitting the optical signal L2 into the two optical signals L31 and L32, with the optical signal L31 transmitted to the phase modulator and the optical signal L32 being the narrow-linewidth laser signal output from the device;
the phase modulator, for modulating the electrical signal E22 onto the optical signal L31 to generate the optical signal LA, which is transmitted to the optical resonator;
the optical resonator, for causing different phase changes in the two sidebands of the optical signal L4 after passing through the optical resonator, and outputting the optical signal L5, which is then transmitted to the second optical fiber coupler;
the second optical fiber coupler, for splitting the optical signal L5 into the two optical signals L61 and L62, with the optical signal L61 transmitted to the EDFA and the optical signal L62 transmitted to the avalanche photodiode;
the avalanche photodiode, for converting the optical signal L62 into an electrical signal E1, which is then transmitted to an electrical bandpass filter;
the electrical bandpass filter, for filtering the electrical signal E1 and outputting an electrical signal E2 to a radio frequency (RF) port of a mixer;
an analog signal source, for generating a reference electrical signal E3, which is transmitted to an electrical power splitter;
the electrical power splitter, for dividing the electrical signal E3 into an electrical signal E41 and an electrical signal E42 with equal power and a phase difference of 90°; wherein the electrical signal E42 is then transmitted to the phase modulator and the electrical signal E41 is then transmitted to a local oscillator port of the mixer;
the mixer, for comparing a phase difference between the electrical signal E41 and the electrical signal E2 to obtain an electrical signal E5, which is then transmitted to a loop filter;
the loop filter, for integrating and processing the electrical signal E5 to generate an electrical signal E61 and an electrical signal E62, with the electrical signal E61 transmitted to an amplifier and the electrical signal E62 transmitted to a servo circuit;
the amplifier, for amplifying a control signal E61 to generate an electrical signal E7 to control the piezoelectric ceramic controller;
the servo circuit, for converting the electrical signal E62 into a current signal E8, which is then transmitted to an adder circuit; and
the adder circuit, for adding the current signal E8 with a current signal E9 output by a constant current source to obtain a feedback control current E10 for the laser;
wherein the electrical signal E7 is configured for controlling the piezoelectric ceramic controller to control the phase of the optical signal in the optical self-injection locking loop, and the electrical signal E10 is configured for feedback control of a laser current to reduce laser phase noise, together achieving closed-loop control of the ultra-stable cavity phase-locked loop.
